(19) United States
(12) Patent Application Publication
(10) Pub. No.: US 2017/0051549 A1
(43) Pub. Date: Feb. 23, 2017

(54) ELECTROMAGNETICALLY DRIVEN AUTOMOTIVE SLIDING DOOR

(71) Applicant: Magna Closures Inc., Newmarket (CA)

(72) Inventor: J.R. Scott Mitchell, Newmarket (CA)

(21) Appl. No.: 15/239,022

(22) Filed: Aug. 17, 2016

Related U.S. Application Data
(60) Provisional application No. 62/207,743, filed on Aug. 20, 2015.

(51) Int. Cl. E05F 15/60; E05D 15/06; B60J 5/04; E06B 3/46

(52) U.S. Cl. CPC E05F 15/60; E06B 3/4636; E05D 15/063; B60J 5/047; E05Y 2201/462; E05Y 2900/531

(57) ABSTRACT

An electromagnetic system for a powered vehicle door for driving the door forward and/or backward between open and closed positions is provided. The electromagnetically driven sliding door includes a door panel with at least one permanent first magnet fixed to the door panel. A plurality of electromagnetic coils are operably mounted adjacent the door panel. The electromagnetic coils are configured in electrical communication with a source of electric current of alternating first and second polarities. The electromagnetic coils are energizable via the electric current to attract the at least one first permanent magnet in response to the first polarity electric current and to repel the at least one first permanent magnet in response to the second polarity electric current to drive the door panel between open and closed positions. Permanent pole magnets can be incorporated to facilitate supporting the door within a door track of the door.

### CROSS-REFERENCE TO RELATED APPLICATION

This application claims the benefit of U.S. Provisional Application Ser. No. 62/207,743, filed Aug. 20, 2015, which is incorporated herein by reference in its entirety.

### FIELD OF THE INVENTION

The present disclosure relates generally to sliding doors for automotive vehicles, and more particularly, to powered sliding doors for automotive vehicles.

### BACKGROUND OF THE INVENTION

This section provides background information which is not necessarily prior art to the inventive concepts associated with the present disclosure.

Vehicles, such as passenger vehicles, are generally equipped with numerous moveable closure members or panels for providing openings and access within and through various defined portions of the vehicle. To enhance operator convenience, many vehicles are now equipped with power-operated closure systems to automatically control movement of all types of closure panels including, without limitation, sliding doors, sun roofs and the like. The powered mechanical advantage is typically provided by an electromechanical drive device including, motor driven gear drives, cable drives, chain drives, belt drives and power screw drives. Automotive sliding doors typically include wheels or rollers to support the mass of the door and facilitate rolling the door between open and closed positions in response to actuation of the electromechanical drive device. Although current electromechanical drive devices generally perform their intended function as initially installed, components brought into dynamic frictional engagement with one another are prone to wear over time, thereby resulting in noise, and typically require servicing. Further yet, mechanical components in such systems typically result in an increased number of components, thereby increasing weight and manufacturing complexity, which in turn typically results in increased cost.

The present disclosure addresses all of these issues, along with others, as will be readily appreciated by one possessing ordinary skill in the art upon viewing the entirety of the disclosure herein.

### SUMMARY OF THE INVENTION

The present disclosure relates to an electromagnetic drive system for a powered door. The electromagnetic system is able to support the mass of the door and/or use alternating polarity electromagnetic coils to drive the door forward and/or backward between open and closed positions.

In accordance with one aspect of the disclosure, an electromagnetically driven sliding door for an automotive vehicle is provided. The electromagnetically driven sliding door includes a door panel with at least one permanent first magnet fixed to the door panel. Further, a plurality of electromagnetic coils are operably mounted adjacent the door panel. The plurality of electromagnetic coils are configured in electrical communication with a source of electric current of alternating first and second polarities. The electromagnetic coils are energizable via the electric current to attract the at least one first permanent magnet in response to the first polarity electric current and to repel the at least one first permanent magnet in response to the second polarity electric current to move the door panel between open and closed positions.

In accordance with a further aspect of the disclosure, the at least one first permanent magnet can be fixed adjacent the lower edge of the door and the plurality of electromagnetic coils can be mounted adjacent the at least one first permanent magnet.

In accordance with a further aspect of the disclosure, the electromagnetically driven sliding door can further include at least one second permanent magnet fixed to the door panel and at least one pole permanent magnet can be mounted adjacent the door panel in magnetically coupled relation with the at least one second permanent magnet to at least partially support the door for sliding movement between the open and closed positions with minimal dynamic friction resulting between the door panel and a door track of the vehicle.

In accordance with a further aspect of the disclosure, the at least one pole permanent magnet can be mounted above the door panel, wherein the second permanent magnet and the at least one pole permanent magnet can be provided having opposite polarities to facilitate suspending the door panel within the door track of the vehicle for minimal sliding friction therewith.

In accordance with a further aspect of the disclosure, the at least one second permanent magnet can be fixed to the door panel adjacent a lower edge of the door panel and the at least one pole permanent magnet can be mounted adjacent the door panel in magnetically coupled relation with the at least one second permanent magnet, wherein the second permanent magnet and the at least one pole permanent magnet can be provided having the same polarities to facilitate suspending the door panel within the door track of the vehicle for minimal sliding friction therewith.

Further areas of applicability will become apparent from the description provided herein. The description and specific examples in this summary are intended for purposes of illustration only and are not intended to limit the scope of the present disclosure.

### BRIEF DESCRIPTION OF THE DRAWINGS

These and other features, benefits and advantages of the present disclosure will become more readily appreciated as the same becomes better understood by reference to the following detailed description, appended claims and accompanying drawings, wherein:

FIG. 1 is an isometric view of an automotive vehicle including a power sliding door in accordance with the disclosure;

FIG. 2 is an enlarged isometric view of the door of the vehicle of FIG. 1 showing an electromagnetic drive system of the door in accordance with one aspect of the disclosure;

FIG. 2A is a view similar to FIG. 2 showing an electromagnetic drive system of the door in accordance with another aspect of the disclosure;

FIG. 2B is a view similar to FIG. 2 showing an electromagnetic drive system of the door in accordance with another aspect of the disclosure;

FIG. 2C is a view similar to FIG. 2 showing an electromagnetic drive system of the door in accordance with another aspect of the disclosure;

FIG. 2D is a view similar to FIG. 2 showing an electromagnetic drive system of the door in accordance with another aspect of the disclosure; and

FIG. 2E is a view similar to FIG. 2 showing an electromagnetic drive system of the door in accordance with yet another aspect of the disclosure.

### DETAILED DESCRIPTION OF THE INVENTION

For purposes of descriptive clarity, the present disclosure is described herein in the context of one or more specific vehicular applications, namely sliding door systems or other sliding vehicle panels (sliding herein includes any linearly translatable door/panel, such as via direct sliding, rollers, wheels, skids, or otherwise). Upon reading the following detailed description in conjunction with the appended drawings and claims, it will be clear that the inventive concepts of the present disclosure can be applied to other systems and applications including linearly translatable, sliding members. The electromagnetically coupled, relatively slidable features combine to extend the useful life of the system components, reduce dynamic friction between system components, reduce the system weight, and further provide a perceived quality enhancement by reducing noise and wear between the moveable components.

The terminology used herein is for the purpose of describing particular example embodiments only and is not intended to be limiting. As used herein, the singular forms “a,” “an,” and “the” may be intended to include the plural forms as well, unless the context clearly indicates otherwise. The terms “compromises,” “comprising,” “including,” and “having,” are inclusive and therefore specify the presence of stated features, integers, steps, operations, elements, and/or components, but do not preclude the presence or addition of one or more other features, integers, steps, operations, elements, and/or components, but do not preclude the presence or addition of one or more other features, integers, steps operations, elements, components, and/or groups thereof. The method steps, processes, and operations described herein are no to be construed as necessarily requiring their performance in the particular order discussed or illustrated, unless specifically identified as an order of performance. It is also to be understood that additional or alternative steps may be employed.

When an element or layer is referred to as being “on,” “engaged to,” “connected to,” or “coupled to” another element or layer, it may be directly on, engaged, connected or coupled to the other element or layer, or intervening elements or layers may be present. In contrast, when an element is referred to as being “directly on,” directly engaged to,” “directly connected to,” or “directly coupled to” another element or layer, there may be no intervening elements or layers present. Other words used to describe the relationship between elements should be interpreted in a like fashion (e.g., “between” versus “directly between,” “adjacent” versus “directly adjacent,” etc.). As used herein, the term “and/or” includes any and all combinations of one or more of the associated listed items.

Although the terms first, second, third, etc. may be used herein to describe various elements, components, regions, layers and/or sections, these elements, components, regions, layers and/or sections should not be limited by these terms. These terms may be only used to distinguish one element, component, region, layer or section from another region, layer or section. Terms such as “first,” “second,” and other numerical terms when used herein do not imply a sequence or order unless clearly indicated by the context. Thus, a first element, component, region, layer or section discussed below could be termed a second element, component, region, layer or section without departing from the teachings of the example embodiments.

Spatially relative terms, such as “inner,” “outer,” “beneath,” “below,” “lower,” “above,” “upper,” and the like, may be used herein for ease of description to describe one element or feature's relationship to another element(s) or feature(s) as illustrated in the figures. Spatially relative terms may be intended to encompass different orientations of the device in use or operation in addition to the orientation depicted in the figures. For example, if the device in the figures is turned over, elements described as “below” or “beneath” other elements or features would then be oriented “above” the other elements or features. Thus, the example term “below” can encompass both an orientation of above and below. The device may be otherwise oriented (rotated 90 degrees or at other orientations) and the spatially relative descriptors used herein interpreted accordingly.

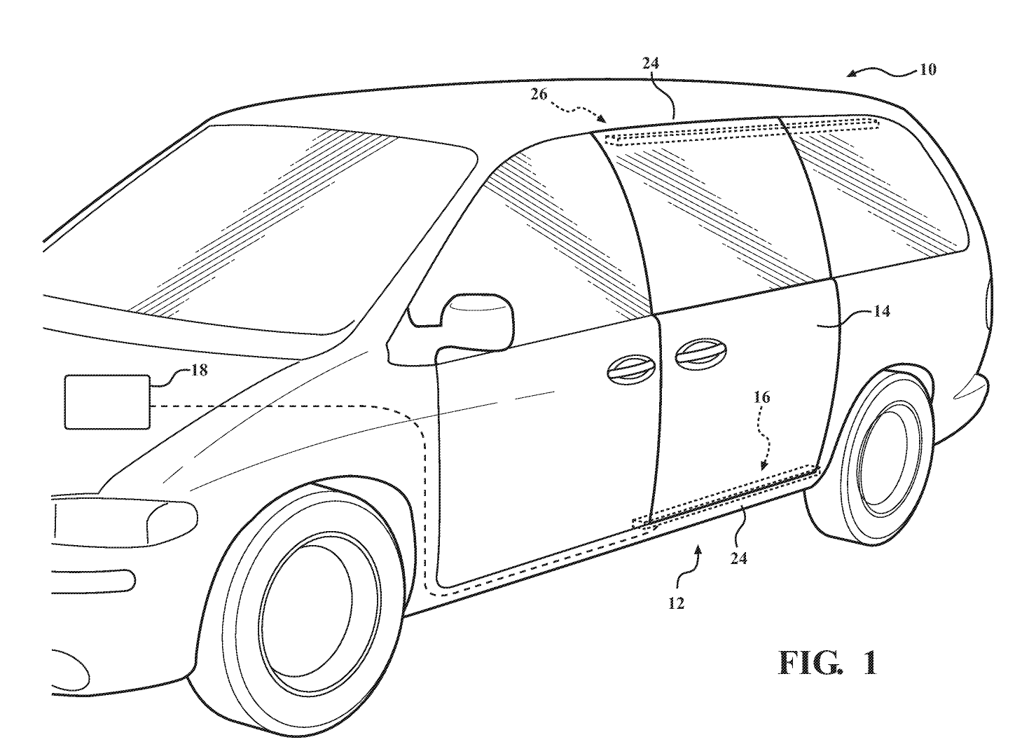

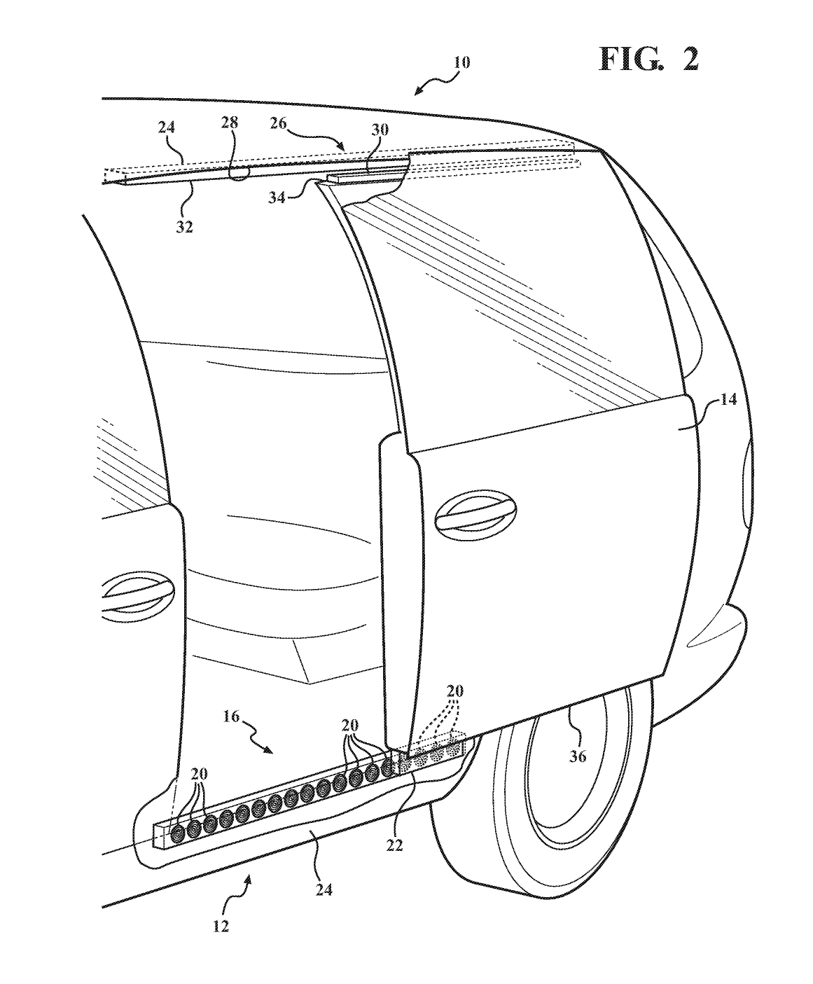

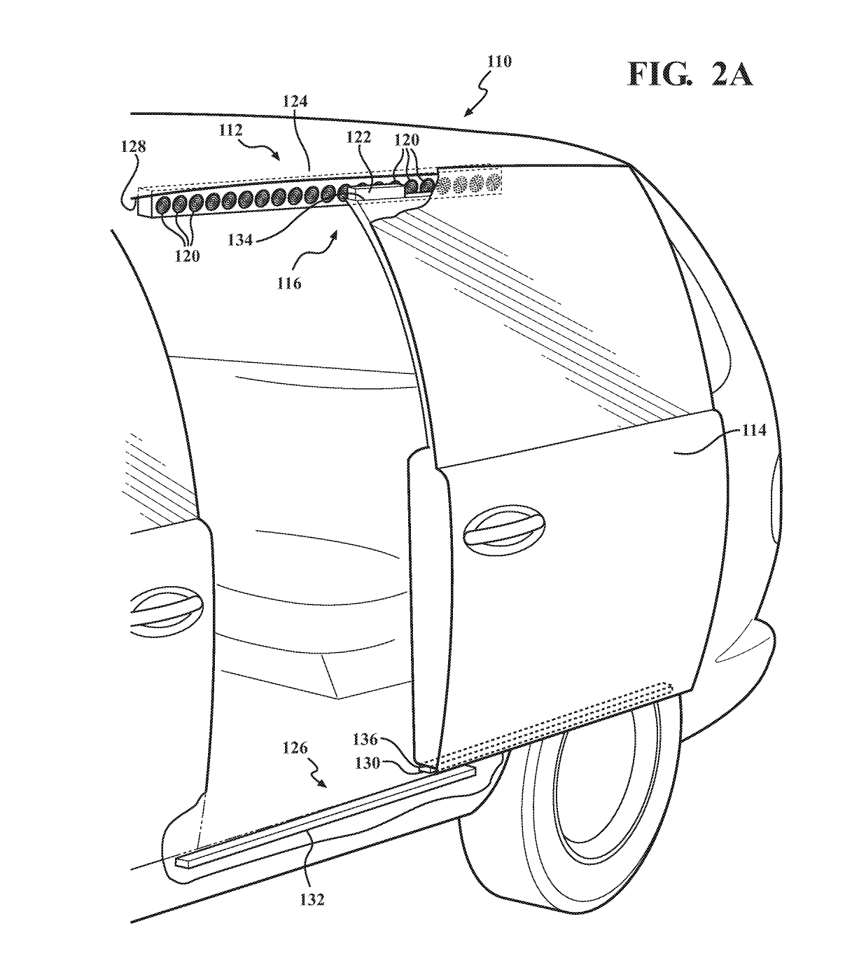

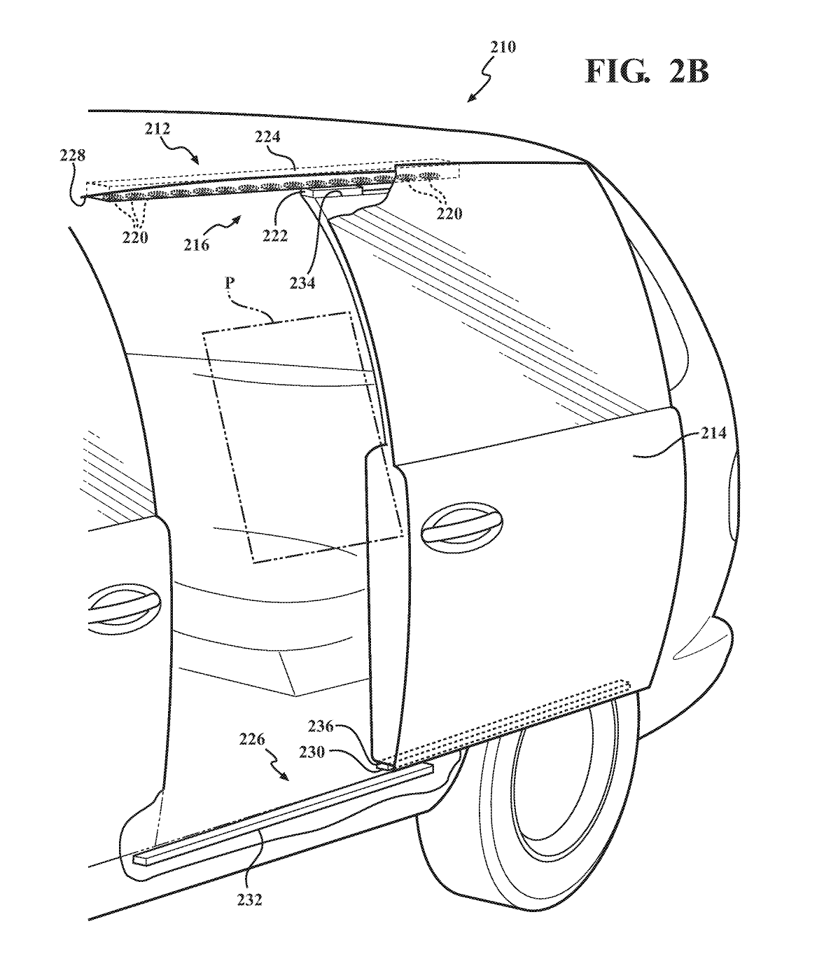

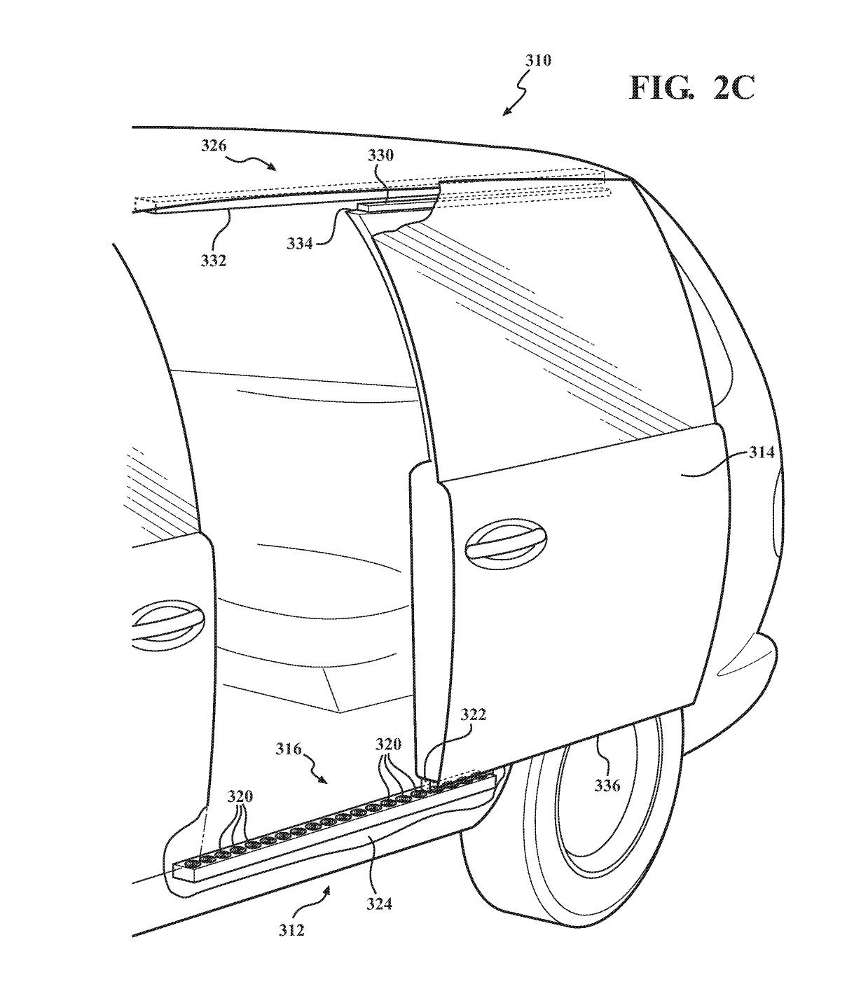

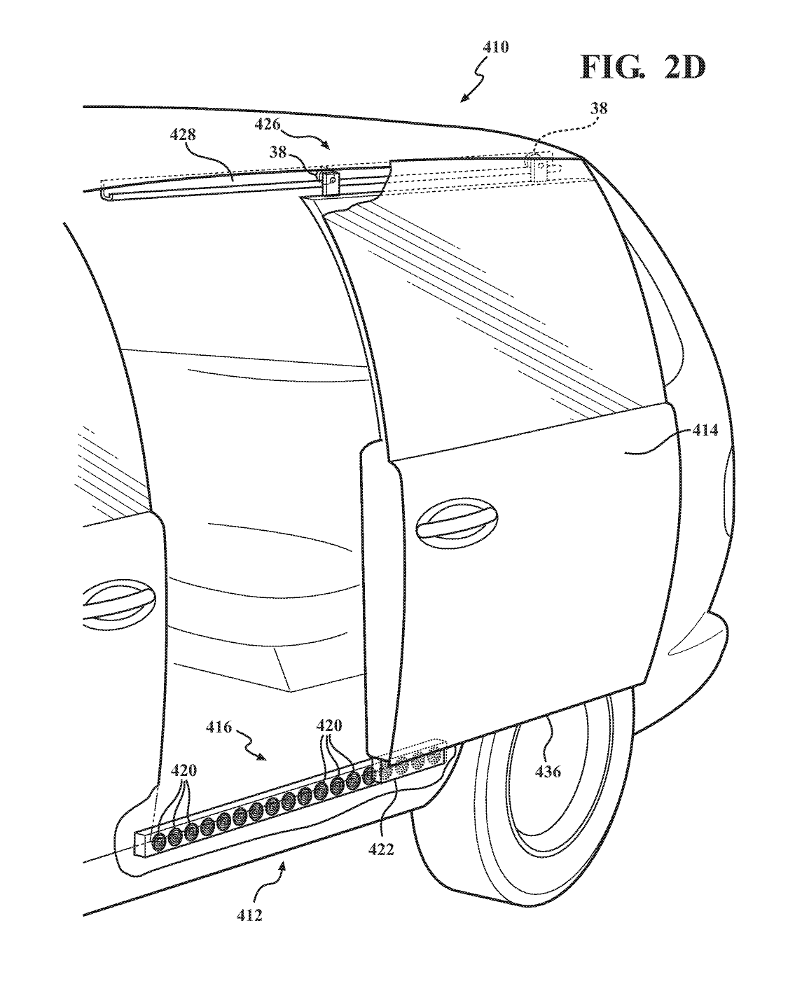

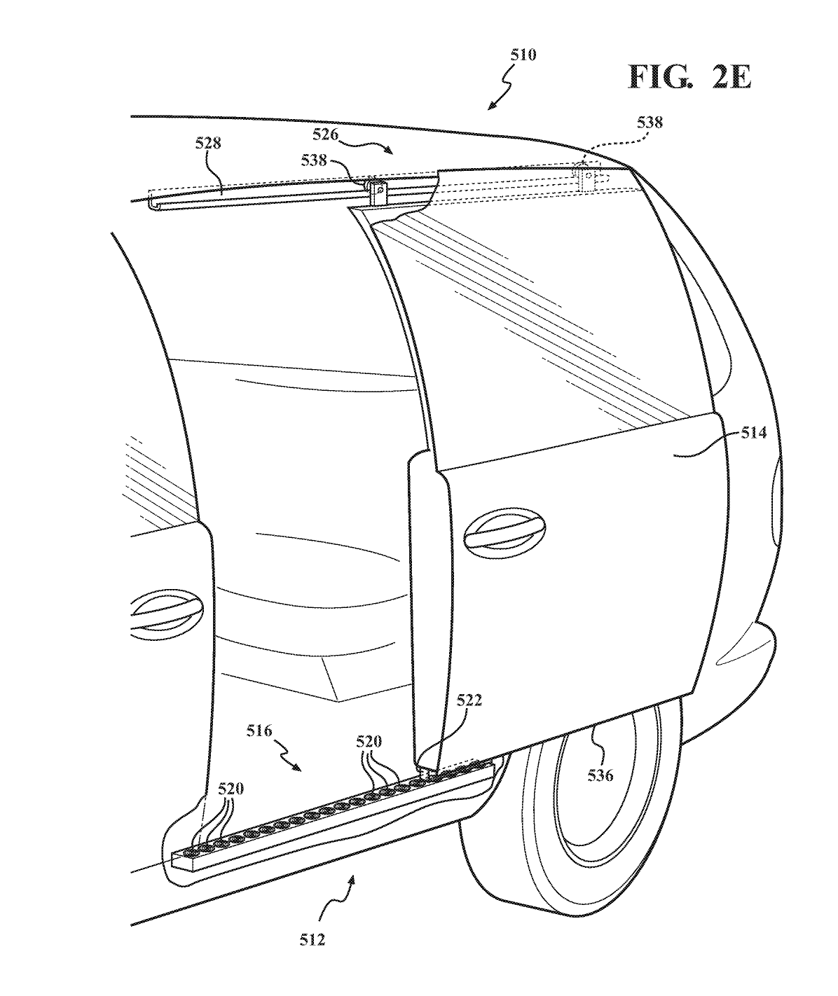

Referring in more detail to the drawings, FIG. 1 illustrates an automotive vehicle 10 including an electromagnetically actuatable sliding door assembly, referred to hereafter simply as assembly 12, in accordance with one aspect of the disclosure. As shown in FIG. 2, in accordance with one aspect of the disclosure, the assembly 12 includes a sliding door panel, referred to hereafter simply as door 14, and an electromagnetic system 16 that is operable to move the door 14 between open and closed positions. The electromagnetic system 16 includes a source of electric current 18 (FIG. 1) of alternating first and second polarities, with the source of electric current 18 being configured in electrical communication with a plurality of electromagnetic propulsion coils, referred to hereafter simply as coils 20. At least one permanent magnet 22, and optionally a plurality of the permanent magnets 22, are fixed to the door 14 for operable magnetic communication with the coils 20. The coils 20 function in relation with one another to selectively and magnetically attract and repel the permanent magnets 22 to move the door 14 between open and closed positions, as commanded by an operator of the vehicle. As a result of the magnetic coupling between the coils 20 and the permanent magnets 22, minimal friction results between the door 14 and a surrounding support frame 24 of the vehicle 10, and thus, minimal wear and noise is generated by the assembly 12 while in use, and further yet, no mechanical linkages/drive members are needed to operate the door 14, thereby reducing weight and cost of the assembly 12.

The assembly 12, in addition to the electromagnetic system 16, can include a magnetic support system 26 to support the door 14, at least in part, within a door guide track 28 of the vehicle 10. The magnetic support system 26 includes at least one pole permanent first permanent magnet 30 fixed to, or adjacent, an upper edge 34 of the door 14, wherein the first permanent magnet 30 has a first polarity, and at least one pole permanent second permanent magnet 32 fixed to the vehicle support frame 24, wherein the second permanent magnet 32 has a second polarity opposite the first polarity. The first and second permanent magnets 30, 32 are in sufficient proximity to one another to couple magnetically. The magnetically attractive force generated between the first and second magnets 30, 32 is sufficient or substantially sufficient to support the weight of the door 14 for minimal friction sliding receipt within the door guide track 28. With the magnetic force coupled between the magnets 30, 32 being attractive, the first permanent magnet 30 is shown as being attached to the door 14 along, or adjacent, the upper edge 34, while the second permanent magnet 32 is shown as being attached to the vehicle support frame 24 above and in spaced relation from the upper edge 34 the door 14.

In FIG. 2A, a vehicle 110 having an assembly 112 constructed in accordance with another aspect of the disclosure is illustrated, wherein the same reference numerals, offset by a factor of 100, are used to identify like features. The assembly 112 includes an electromagnetic system 116 that is operable to move a sliding door 114 between open and closed positions in response to a source of electric current of alternating first and second polarities energizing a plurality of electromagnetic propulsion coils 120, as discussed above. At least one permanent magnet 122 is fixed to the door 114 for operable magnetic communication with the coils 120, such that the coils 120 are selectively energized in relation with one another by the alternating current to selectively and magnetically attract and repel the permanent magnet(s) 122 to move the door 114 between open and closed positions. In contrast to the embodiment of FIG. 2, the electromagnetic system 116 is operably attached along an upper edge 134 of the door 114, with the coils 120 shown as being operably attached to a vehicle support frame 124 and the permanent magnet 122 being operably attached to the upper edge 134 of the door 114. As shown, the coils 120 are oriented to face outwardly from the vehicle interior, while the permanent magnet(s) 122 faces the coils 120 in laterally aligned and spaced relation therefrom.

The assembly 112, like the previous assembly 12, can include a magnetic support system 126 to support the door 114, at least in part. Rather than the magnetic support system 126 supporting weight of the door 114 from above the door 114, the magnetic support system 126 is shown supporting the weight, or substantial portion thereof, from below the door 114. In this instance, the magnetic support system 126 includes at least one pole permanent first permanent magnet 130 fixed to a lower or bottom surface 136 of the door 114, wherein the first permanent magnet 130 has a first polarity, and at least one pole permanent second permanent magnet 132 fixed to the vehicle support frame 124 below the door 114, wherein the second permanent magnet 132 has a second polarity the same as the first polarity of the first magnet 130. The first and second permanent magnets 130, 132 are in sufficient proximity to one another to couple magnetically. The magnetically repelling force generated between the first and second magnets 130, 132 is sufficient or substantially sufficient to support the weight of the door 114 for minimal friction sliding receipt within the door guide track 128.

In FIG. 2B, a vehicle 210 having an assembly 212 constructed in accordance with another aspect of the disclosure is illustrated, wherein the same reference numerals, offset by a factor of 200, are used to identify like features. The assembly 212 includes an electromagnetic system 216 that is operable to move a sliding door 214 between open and closed positions in response to a source of electric current of alternating first and second polarities energizing a plurality of electromagnetic propulsion coils 220, as discussed above. The assembly 212 is similar to the assembly 112 of FIG. 2A, including at least one permanent magnet 222 fixed to an upper edge 234 of the door 214 for operable magnetic communication with electromagnetic propulsion coils 220; however, rather than the coils 220 facing laterally outwardly from the vehicle interior, the coils 220 are fixed to the support frame 224 to face downwardly, such that the coils 220 are located above the permanent magnet(s) 222 and lie generally within a plane (P) of the door 214. As with the previous embodiments, the coils 220 are selectively energized in relation with one another by the alternating current to selectively and magnetically attract and repel the permanent magnet(s) 222 to move the door 214 between open and closed positions.

The assembly 212, like the previous assemblies 12, 112, can include a magnetic support system 226 to support the door 214, at least in part. Like the magnetic support system 126 of FIG. 2A, the magnetic support system 226 is shown supporting the weight, or substantial portion thereof, from below the door 214. As such, the magnetic support system 226 includes at least one pole permanent first permanent magnet 230 fixed to a lower or bottom surface 236 of the door 214, wherein the first permanent magnet 230 has a first polarity, and at least one pole permanent second permanent magnet 232 fixed to the vehicle support frame 224 below the door 214, wherein the second permanent magnet 232 has a second polarity the same as the first polarity. The first and second permanent magnets 230, 232 are in sufficient proximity to one another to couple magnetically. The magnetically repelling force generated between the first and second magnets 230, 232 is sufficient or substantially sufficient to support the weight of the door 214 for minimal friction sliding receipt within the door guide track 228.

In FIG. 2C, a vehicle 310 having an assembly 312 constructed in accordance with another aspect of the disclosure is illustrated, wherein the same reference numerals, offset by a factor of 300, are used to identify like features. The assembly 312 includes an electromagnetic system 316 that is operable to move a sliding door 314 between open and closed positions in response to a source of electric current of alternating first and second polarities energizing a plurality of electromagnetic propulsion coils 320, as discussed above. The assembly 312 is similar to the assembly 12 of FIG. 2, including at least one permanent magnet 322 fixed adjacent a lower edge 336 of the door 314 for operable magnetic communication with electromagnetic propulsion coils 320; however, rather than the coils 320 facing laterally outwardly from the vehicle interior, the coils 320 are fixed to the support frame 324 to face upwardly, such that the coils 320 are located directly below the permanent magnet(s) 322. As with the previous embodiments, the coils 320 are selectively energized in relation with one another by the alternating current to selectively and magnetically attract and repel the permanent magnet(s) 322 to move the door 314 between open and closed positions.

The assembly 312, like the previous assemblies 12, 112, 212, can include a magnetic support system 326 to support the door 314, at least in part. Like the magnetic support system 26 of FIG. 2, the magnetic support system 326 is shown supporting the weight, or substantial portion thereof, from above the door 314. As such, the magnetic support system 326 includes at least one pole permanent first permanent magnet 330 fixed to, or adjacent, an upper edge 334 of the door 314, wherein the first permanent magnet 330 has a first polarity, and at least one pole permanent second permanent magnet 332 fixed to the vehicle support frame 324 above the door 314, wherein the second permanent magnet 332 has a second polarity opposite the first polarity. Given the discussion above with regard to FIG. 2, no further explanation is believed necessary, as one skilled in the art will readily appreciate the operable functionality of the system 326 and possible variations thereof.

In FIG. 2D, a vehicle 410 having an assembly 412 constructed in accordance with another aspect of the disclosure is illustrated, wherein the same reference numerals, offset by a factor of 400, are used to identify like features. The assembly 412 includes an electromagnetic system 416 that is operable to move a sliding door 414 between open and closed positions in response to a source of electric current of alternating first and second polarities energizing a plurality of electromagnetic propulsion coils 420, as discussed above. The assembly 412 is similar to the assembly 12 of FIG. 2, including at least one permanent magnet 422 fixed adjacent a lower edge 436 of the door 414 for operable magnetic communication with the laterally outwardly facing electromagnetic propulsion coils 420. Further yet, the assembly 412 includes a support system 426 to support the door 414, at least in part, for sliding translation between the open and closed positions. However, unlike the previously discussed embodiment, the support system is provided by wheels or rollers 38 that roll within the door guide track 428. Otherwise, the assembly 412 is generally the same as discussed above for the assembly 12, and thus, no further discussion is believed necessary, as one skilled in the art will readily appreciate the operable functionality of the assembly 412 and possible variations thereof.

In FIG. 2E, a vehicle 510 having an assembly 512 constructed in accordance with another aspect of the disclosure is illustrated, wherein the same reference numerals, offset by a factor of 500, are used to identify like features. The assembly 512 includes an electromagnetic system 516 that is operable to move a sliding door 514 between open and closed positions in response to a source of electric current of alternating first and second polarities energizing a plurality of electromagnetic propulsion coils 520, as discussed above. The assembly 512 is similar to the assembly 312 of FIG. 2C, including at least one permanent magnet 522 fixed adjacent a lower edge 536 of the door 514 for operable magnetic communication with the upwardly facing electromagnetic propulsion coils 520. Further yet, the assembly 512 includes a support system 526 to support the door 514, at least in part, for sliding translation between the open and closed positions. However, unlike the support system of FIG. 2C, the support system is provided as discussed above with regard to FIG. 2D, namely, having wheels or rollers 538 that roll within the door guide track 528. Otherwise, the assembly 512 is generally the same as discussed above for the assembly 312, and thus, no further discussion is believed necessary, as one skilled in the art will readily appreciate the operable functionality of the assembly 512 and possible variations thereof.

The foregoing description of the embodiments has been provided for purposes of illustration and description. It is not intended to be exhaustive or to limit the disclosure or claims. Individual elements or features of a particular embodiment are generally not limited to that particular embodiment, but, where applicable, are interchangeable and can be used in a different embodiment, even if not specifically shown or described. Many modifications and variations to the above embodiments, and alternate embodiments and aspects are possible in light of the above disclosure. Such variations are not to be regarded as a departure from the disclosure, and all such modifications are intended to be included within the scope of the disclosure. The modifications and variations to the above embodiments, alternate embodiments, and aspects may be practiced otherwise than as specifically described while falling within the scope of the following claims.

What is claimed is:

1. An electromagnetically driven sliding door for an automotive vehicle, comprising:
a door panel;
at least one first permanent magnet fixed to said door panel; and
a plurality of electromagnetic coils operably mounted adjacent said door panel, said plurality of electromagnetic coils being configured in electrical communication with a source of electric current of alternating first and second polarities, said electromagnetic coils being energizable to attract said at least one first permanent magnet in response to said first polarity electric current and to repel said at least one first permanent magnet in response to said second polarity electric current to move said door panel between open and closed positions.

2. The electromagnetically driven sliding door of claim 1, wherein said door panel has an upper edge and a lower edge, said at least one first permanent magnet being fixed adjacent one of said upper and lower edges.

3. The electromagnetically driven sliding door of claim 2, wherein said plurality of electromagnetic coils are mounted adjacent said at least one first permanent magnet.

4. The electromagnetically driven sliding door of claim 3, wherein said at least one first permanent magnet is fixed adjacent said lower edge.

5. The electromagnetically driven sliding door of claim 4, further including at least one second permanent magnet fixed to said door panel adjacent said upper edge and at least one pole permanent magnet mounted adjacent said door panel in magnetically coupled relation with said at least one second permanent magnet.

6. The electromagnetically driven sliding door of claim 5 wherein said at least one second permanent magnet and said at least one pole permanent magnet have opposite polarities.

7. The electromagnetically driven sliding door of claim 3, wherein said at least one permanent magnet is fixed adjacent said upper edge.

8. The electromagnetically driven sliding door of claim 7, further including at least one second permanent magnet fixed to said door panel adjacent said lower edge and at least one pole permanent magnet mounted adjacent said door panel in magnetically coupled relation with said at least one second permanent magnet.

9. The electromagnetically driven sliding door of claim 8 wherein said at least one second permanent magnet and said at least one pole permanent magnet have the same polarity.

10. The electromagnetically driven sliding door of claim 1, wherein said door panel has an upper edge and a lower edge, further including at least one second permanent magnet fixed to said door panel adjacent at least one of said upper edge and said lower edge, and further including at least one pole permanent magnet mounted adjacent said door panel in magnetically coupled relation with said at least one second permanent magnet.

11. The electromagnetically driven sliding door of claim 10, wherein said at least one second permanent magnet includes a second permanent magnet fixed adjacent said upper edge, said second permanent magnet and said at least one pole permanent magnet have opposite polarities.

12. The electromagnetically driven sliding door of claim 10, wherein said at least one second permanent magnet includes a second permanent magnet fixed adjacent said lower edge, said at least one second permanent magnet fixed adjacent said lower edge and said at least one pole permanent magnet adjacent thereto have the same polarity.

13. The electromagnetically driven sliding door of claim 1, wherein said door panel extends generally along a plane between an upper edge and a lower edge, said at least one first permanent magnet being fixed adjacent one of said upper and lower edges and said plurality of electromagnetic coils being mounted within said plane.

14. The electromagnetically driven sliding door of claim 13, wherein said plurality of electromagnetic coils are mounted adjacent said upper edge.

15. The electromagnetically driven sliding door of claim 13, wherein said plurality of electromagnetic coils are mounted adjacent said lower edge.
